(19) United States
(12) Patent Application Publication
(10) Pub. No.: US 2012/0215415 A1
(43) Pub. Date: Aug. 23, 2012

(54) METHOD FOR OPERATING A DRIVER ASSISTANCE SYSTEM OF A MOTOR VEHICLE AND DRIVER ASSISTANCE SYSTEM

(75) Inventor: Thomas SCHRAMM, Mainz (DE)

(73) Assignee: GM GLOBAL TECHNOLOGY OPERATIONS LLC, Detroit, MI (US)

(21) Appl. No.: 13/372,743

(22) Filed: Feb. 14, 2012

(30) Foreign Application Priority Data
Feb. 23, 2011 (DE) 10 2011 012 096.3

(51) Int. Cl. B60K 31/00

(52) U.S. Cl. 701/93

(57) ABSTRACT

A method is provided for operating a driver assistance system of a motor vehicle, the driver assistance system implemented to regulate a speed of the motor vehicle and the method including, but not limited to determine at least one parameter characterizing an acceleration behavior of a driver of the motor vehicle and including at least one driver-specific acceleration value. In addition, a target value of the speed of the motor vehicle is set. The speed is regulated to the set target value in at least one first phase and one second phase, in the first phase, after beginning the regulation to the set target value, the speed of the motor vehicle adapted based on the at least one driver-specific acceleration value.

### CROSS-REFERENCE TO RELATED APPLICATION

This application claims priority to German Patent Application No. 10 2011 012 096.3, filed Feb. 23, 2011, which is incorporated herein by reference in its entirety.

### TECHNICAL FIELD

The technical field relates to methods for operating a driver assistance system of a motor vehicle, driver assistance systems for a motor vehicle, a computer program product, and a computer-readable medium.

### BACKGROUND

A method is known from DE 44 01 416 C2 for gradual driving style classification between calm and dynamic driving styles. In the method, vehicle sensors sample measured variables, which are indicative of the driving style, during travel and at least one driving style index is ascertained by means of at least a part of the acquired measured values employing a respective associated previously stored measured variables/driving style characteristic map. An acceleration index about the acceleration behavior, a braking index about the braking behavior, and a steering index about the steering behavior are ascertained separately, using which the input parameters for control or regulating devices of various control or regulating systems, which adapt to the driving style, of a motor vehicle are settable as a function, which is pre-definable specifically for the respective control or regulating device, of the acceleration, braking, and/or steering index.

At least one object is to specify methods for operating a driver assistance system of a motor vehicle, driver assistance systems for a motor vehicle, a computer program product, and a computer-readable medium, which allow improved personalized adaptation of the respective driver assistance system. In addition, other objects, desirable features, and characteristics will become apparent from the subsequent summary and detailed description, and the appended claims, taken in conjunction with the accompanying drawings and this background.

### SUMMARY

A method is provided for operating a driver assistance system of a motor vehicle. The driver assistance system is implemented for regulating a speed of the motor vehicle, which has the following steps. At least one parameter is determined, the at least one parameter characterizing an acceleration behavior of a driver of the motor vehicle and including at least one driver-specific acceleration value. In addition, a target value of the speed of the motor vehicle is set. The regulation of the speed to the set target value is performed in at least one first phase and one second phase, in the first phase, after beginning the regulation to the set target value, the speed of the motor vehicle is adapted based on the at least one driver-specific acceleration value.

A method is also provided for operating a driver assistance system of a motor vehicle, the driver assistance system implemented to regulate a following distance of the motor vehicle to a further motor vehicle. According to an embodiment, the method has the following steps. At least one parameter is determined, the at least one parameter characterizing an acceleration behavior of a driver of the motor vehicle and including at least one driver-specific acceleration value. Furthermore, a target value of the following distance of the motor vehicle is set. The regulation of the following distance to the set target value is performed in at least one first phase and one second phase, in the first phase, after beginning the regulation to be set target value, the speed of the motor vehicle being adapted based on the at least one driver-specific acceleration value.

The method for operating a driver assistance system according to the mentioned embodiments allows an improved personalized adaptation of the respective driver assistance system. This is performed by the determination of the at least one parameter that characterizes the acceleration behavior of the driver and the adaptation of the speed of the motor vehicle based on the at least one driver-specific acceleration value. The acceleration set by the driver assistance system therefore corresponds to an improved extent to acceleration that the driver of the motor vehicle would set himself. This advantageously allows an increase in comfort for the driver of the motor vehicle. In addition, the acceptance of the respective driver assistance system is thus increased.

The driver assistance system according to the first-mentioned embodiment is typically a speed regulation system, which is also referred to as a CC (cruise control), or a distance regulation system, which is also referred to as an ACC (adaptive cruise control). The adaptive cruise control is also in speed regulation operation in this case, i.e., no target vehicle has been selected for a following distance regulation. The driver assistance system according to the second-mentioned embodiment is typically an adaptive cruise control of the motor vehicle.

In a further embodiment, in addition, at least one parameter that characterizes a braking behavior of the driver of the motor vehicle is determined, the at least one parameter including at least one driver-specific deceleration value. In the first phase after beginning the regulation to the set target value, i.e., the regulation to the set target value of the speed for the first-mentioned embodiment or the regulation to the set target value of the following distance for the second-mentioned embodiment, the speed of the motor vehicle is additionally adapted based on the at least one driver-specific deceleration value. In this way, in addition to the acceleration behavior, the braking behavior of the driver is also used for the driver assistance system, whereby it can be adapted to the driving style of the driver to a further increased extent.

Furthermore, at least one value of a yaw rate and/or a lateral acceleration of the motor vehicle can additionally or alternatively be ascertained. In the first phase after the beginning of the regulation to the set target value, i.e., the regulation to the set target value of the speed or the regulation to the set target value of the following distance, in this embodiment, the speed of the motor vehicle is additionally adapted based on the at least one ascertained value. The mentioned characteristic values advantageously provide a statement about the sportiness of the driving style of the driver and therefore form a measure of the level of acceleration or deceleration values for the respective driver assistance system.

The determination of the at least one parameter, i.e., the at least one parameter which characterizes the acceleration behavior of the driver and/or the at least one parameter that characterizes the braking behavior of the driver, is performed in one embodiment for a predetermined duration after a starting procedure of the motor vehicle. The predetermined duration is also referred to as the so-called baseline phase and lasts approximately 15 minutes, for example. The mentioned embodiment therefore allows a simple way of determining the respective parameter.

In a further embodiment, the at least one parameter is determined continuously during operation of the motor vehicle. This embodiment has the advantage that the respective instantaneous environmental or traffic situation, in which the motor vehicle is located, can be taken into consideration to an increased extent for the driver assistance system.

Furthermore, the at least one parameter can be determined by means of a personalized preset assigned to at least one ignition key of the motor vehicle. This allows a driver coding via the corresponding vehicle key and thus a simplified method sequence during the operation of the motor vehicle. In a further embodiment, the at least one parameter is determined by means of an input by an occupant of the motor vehicle, in particular an input by the driver of the motor vehicle. The driver assistance system can thus be adapted in a personalized manner to the greatest possible extent. In a further embodiment of the method, the at least one parameter is stored in a storage device. The storage device is preferably a component of the motor vehicle. The at least one parameter is thus advantageously available for future operating procedures of the driver assistance system.

In the second phase of the regulation of the speed or the regulation of the following distance to the set target value, the speed of the motor vehicle can also be adapted based on the at least one driver-specific acceleration value. In addition, the speed of the motor vehicle can additionally be adapted in the second phase based on the at least one driver-specific deceleration value and/or based on the at least one ascertained value of the yaw rate and/or the lateral acceleration of the motor vehicle. An adaptation of the driver assistance system to the driving style of the driver can thus also be performed in the second phase of the regulation.

In an alternative embodiment, the speed of the motor vehicle is adapted in the second phase of the regulation of the speed or the regulation of the following distance based on a predetermined acceleration value. Furthermore, the speed of the motor vehicle can additionally be adapted in the second phase based on a predetermined deceleration value. In the mentioned embodiments, the level of the acceleration or the deceleration in the second phase of the regulation is therefore a fixed parameter. This allows a simplified performance of the method in the second phase. This proceeds from the consideration that the deviation between actual value and the target value of the variable to be regulated in the second phase is significantly less than in the first phase, where a driver-specific adaptation can be omitted in the second phase, without thus impairing the acceptance of the respective driver assistance system.

The application additionally relates to a driver assistance system for a motor vehicle, which is implemented to regulate a speed of the motor vehicle. The driver assistance system has a first ascertainment device, which is implemented to determine at least one parameter, the at least one parameter characterizing an acceleration behavior of a driver of the motor vehicle and including at least one driver-specific acceleration value. Furthermore, the driver assistance system has a setting device, which is implemented to set a target value of the speed of the motor vehicle. The regulation of the speed to the set target value is performed in at least one first phase and one second phase, the driver assistance system implemented to adapt the speed of the motor vehicle based on the at least one driver-specific acceleration value in the first phase after beginning the regulation to the set target value.

Furthermore, a driver assistance system is provided for a motor vehicle, which is implemented for regulating a following distance of the motor vehicle to a further motor vehicle. The driver assistance system has a first ascertainment device, which is implemented to determine at least one parameter, the at least one parameter characterizing an acceleration behavior of a driver of the motor vehicle and including at least one driver-specific acceleration value. In addition, the driver assistance system has a setting device, which is implemented to set a target value of the following distance of the motor vehicle. The regulation of the following distance to the set target value is performed in at least one first phase and one second phase, the driver assistance system being implemented to adapt the speed of the motor vehicle based on the at least one driver-specific acceleration value in the first phase after beginning the regulation to the set target value.

The driver assistance systems have the advantages already mentioned in connection with the respective method according to the invention, which will not be listed once again here to avoid repetitions.

In a further embodiment, the driver assistance system additionally has a second ascertainment device, which is implemented to determine at least one parameter which characterizes a braking behavior of the driver of the motor vehicle, the at least one parameter including at least one driver-specific deceleration value. The driver assistance system is additionally implemented in this embodiment to adapt the speed of the motor vehicle based on the at least one driver-specific deceleration value in the first phase after beginning the regulation to the set target value.

Furthermore, a motor vehicle is provided that has a driver assistance system according to one of the mentioned embodiments. The motor vehicle is a passenger automobile, for example. In addition, the application relates to a computer program product, which, when it is executed on a computer unit of a driver assistance system of a motor vehicle, the driver assistance system implemented to regulate a speed of the motor vehicle, instructs the computer unit to execute the following steps. The computer unit is instructed to determine at least one parameter, the at least one parameter characterizing an acceleration behavior of a driver of the motor vehicle and including at least one driver-specific acceleration value. In addition, the computer unit is instructed to set a target value of the speed of the motor vehicle. The regulation of the speed to the set target value is performed in at least one first phase and one second phase, the computer unit being instructed in the first phase, after beginning the regulation to the set target value, to adapt the speed of the motor vehicle based on the at least one driver-specific acceleration value.

Furthermore, a computer program product is provided, which, when it is executed on a computer unit of a driver assistance system of a motor vehicle, the driver assistance system being implemented to regulate a following distance of the motor vehicle to a further motor vehicle, instructs the computer unit to execute the following steps. The computer unit is instructed to determine at least one parameter, the at least one parameter characterizing an acceleration behavior of a driver of the motor vehicle and including at least one driver-specific acceleration value. In addition, the computer unit is instructed to set a target value of the following distance of the motor vehicle. The regulation of the following distance to the set target value is performed in at least one first phase and one second phase, the computer unit being instructed in the first phase, after beginning the regulation to the set target value, to adapt the speed of the motor vehicle based on the at least one driver-specific acceleration value. Furthermore, a computer-readable medium is provided on which a computer program product according to at least one of the two mentioned embodiments is stored.

The motor vehicle, the computer program products, and the computer-readable medium have the advantages already mentioned in connection with the method according to the application, which will not be listed once again here to avoid repetitions.

### BRIEF DESCRIPTION OF THE DRAWINGS

The present invention will hereinafter be described in conjunction with the following drawing figures, wherein like numerals denote like elements, and:

FIG. 1A shows a flow chart of a method for operating a driver assistance system of a motor vehicle according to a first embodiment;

FIG. 1B shows a flow chart of a method for operating a driver assistance system of a motor vehicle according to a second embodiment;

FIG. 2A shows a flow chart of a method for operating a driver assistance system of a motor vehicle according to a third embodiment;

FIG. 2B shows a flow chart of a method for operating a driver assistance system of a motor vehicle according to a fourth embodiment;

FIG. 3A shows an example of a traffic situation in which the method according to the application can be used;

FIG. 3B shows the first motor vehicle shown in FIG. 3A;

FIG. 4A shows a driver assistance system according to a first embodiment;

FIG. 4B shows a driver assistance system according to a second embodiment;

FIG. 5A shows a driver assistance system according to a third embodiment; and

FIG. 5B shows a driver assistance system according to a fourth embodiment.

### DETAILED DESCRIPTION

The following detailed description is merely exemplary in nature and is not intended to application and uses. Furthermore, there is no intention to be bound by any theory presented in the preceding background or summary or the following detailed description.

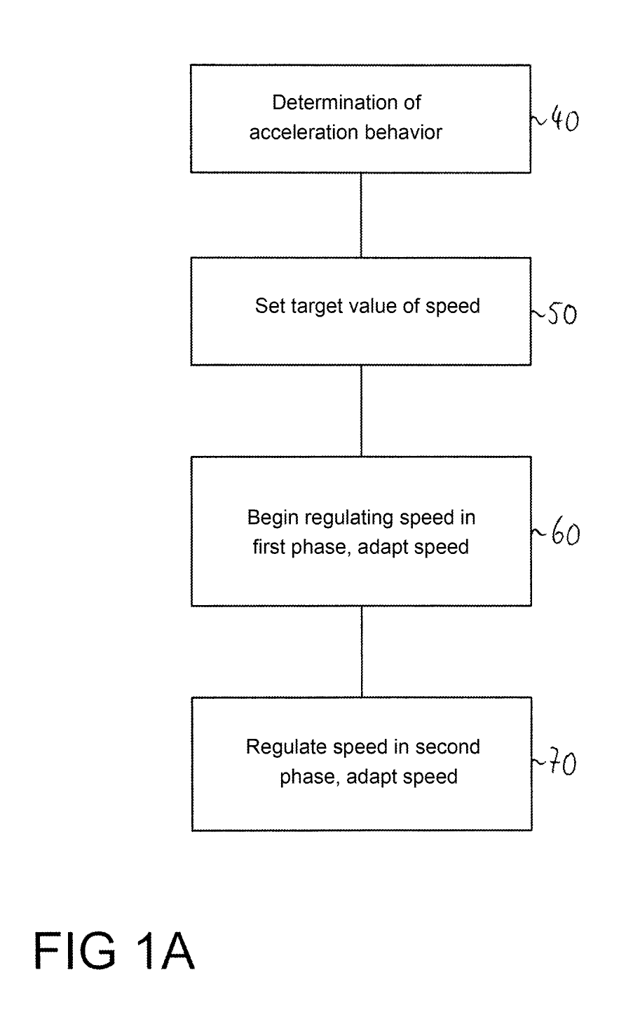

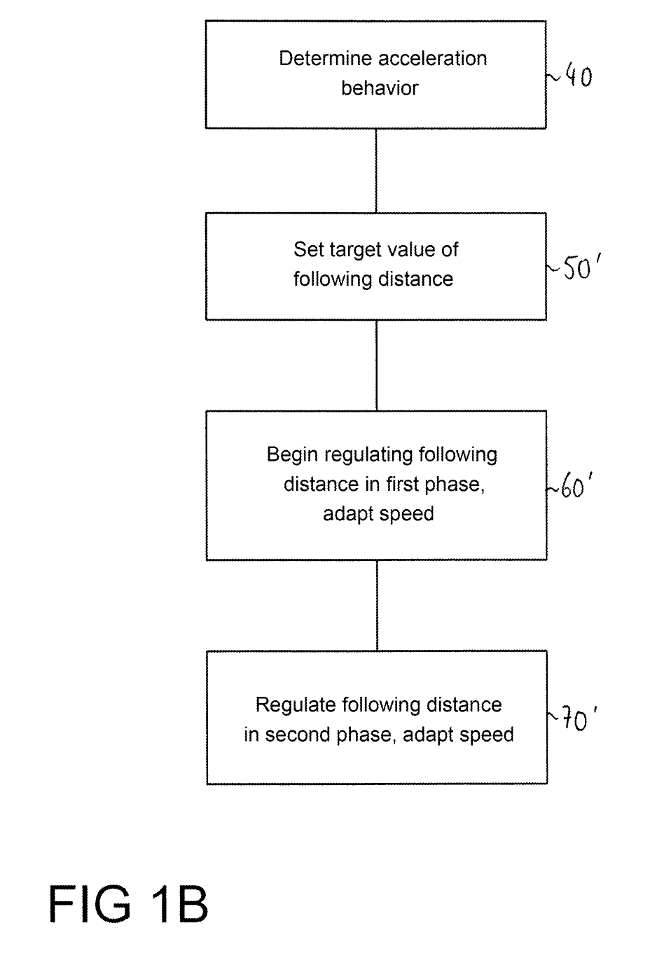

FIG. 1A shows a flow chart of a method for operating a driver assistance system of a motor vehicle according to a first embodiment. The driver assistance system is implemented to regulate a speed of the motor vehicle and the motor vehicle is a passenger automobile, for example. In a step 40, at least one parameter is determined, the at least one parameter characterizing an acceleration behavior of a driver of the motor vehicle and including at least one driver-specific acceleration value. The determination of the at least one parameter which characterizes the acceleration behavior of the driver can include a determination of a time fraction of acceleration values which are above a predetermined threshold value. Furthermore, a frequency of acceleration values, which lie above a predetermined threshold value, can be ascertained. For example, the time fraction or the frequency of acceleration values can be ascertained which exceed approximately 0.5 g, with g representing the acceleration of Earth's gravity (g≈9.81 m/s²). Furthermore, a mean value of acceleration values can be ascertained. The at least one parameter can be determined for a predetermined duration after a starting procedure of the motor vehicle or continuously during operation of the motor vehicle. Furthermore, the at least one parameter can be determined by means of a personalized preset, which is assigned to at least one ignition key of the motor vehicle, or by means of an input by an occupant of the motor vehicle, for example, the driver.

In a step 50, a target value of the speed to be regulated of the motor vehicle is set in the embodiment shown by an occupant of the motor vehicle, for example, by the driver of the motor vehicle. The setting of the target value of the speed can also be performed before or during the determination of the at least one parameter, i.e., the step 50 can be performed before or during the step 40.

In a step 60, the regulation to the set target value of the speed begins. The speed is regulated to the set target value in a first phase and a second phase, the speed of the motor vehicle being adapted based on the at least one driver-specific acceleration value in the first phase, as shown in step 60. The speed of the motor vehicle can be adapted in the first phase in such a manner, for example, that based on the ascertained driver-specific acceleration value, a predetermined acceleration value for the driver assistance system is changed. For example, the predetermined value of the acceleration can be increased by the factor of approximately 1.5 in the event of an ascertained sporty acceleration behavior of the driver, while in contrast the predetermined value is reduced by one third, for example, in the event of an ascertained comfortable driving behavior of the driver. Furthermore, the predetermined value can be adapted continuously based on the ascertained driver-specific acceleration value.

In a step 70, which represents the second phase of the regulation of the speed, in the embodiment shown, the speed of the motor vehicle is adapted based on the predetermined acceleration value and therefore independently of the driving style of the driver. Furthermore, the determination of the acceleration behavior of the driver can include ascertaining at least one value of a yaw rate and/or a lateral acceleration of the motor vehicle. In the first phase after beginning the regulation to the set target value of the speed, the speed of the motor vehicle is additionally adapted in this embodiment based on the at least one ascertained value.

FIG. 1B shows a flow chart of a method for operating a driver assistance system of a motor vehicle according to a second embodiment. The driver assistance system is implemented to regulate a following distance of the motor vehicle to a further motor vehicle and the motor vehicle and the further motor vehicle are passenger automobiles, for example. In a step 40, at least one parameter is determined, the at least one parameter characterizing an acceleration behavior of a driver of the motor vehicle and including at least one driver-specific acceleration value, corresponding to step 40 of the first embodiment shown in FIG. 1A.

In a step 50′, a target value is set of the following distance of the motor vehicle to the further motor vehicle, which is ascertained as the target vehicle for the regulation of the following distance, by an occupant of the motor vehicle, for example, by the driver. The regulation of the following distance to the set target value is performed in the embodiment shown in a first phase and a second phase. The speed of the motor vehicle is adapted based on the at least one driver-specific acceleration value in the first phase after beginning the regulation to the set target value, as shown in a step 60′.

During the second phase of the regulation of the following distance to the set target value, in a step 70′, the speed of the motor vehicle is adapted based on a predetermined acceleration value and therefore independently of the driving style of the driver. Furthermore, the determination of the acceleration behavior of the driver can include ascertaining at least one value of a yaw rate and/or a lateral acceleration of the motor vehicle. In the first phase after beginning the regulation to the set target value of the speed, the speed of the motor vehicle is additionally adapted in this embodiment based on the at least one ascertained value.

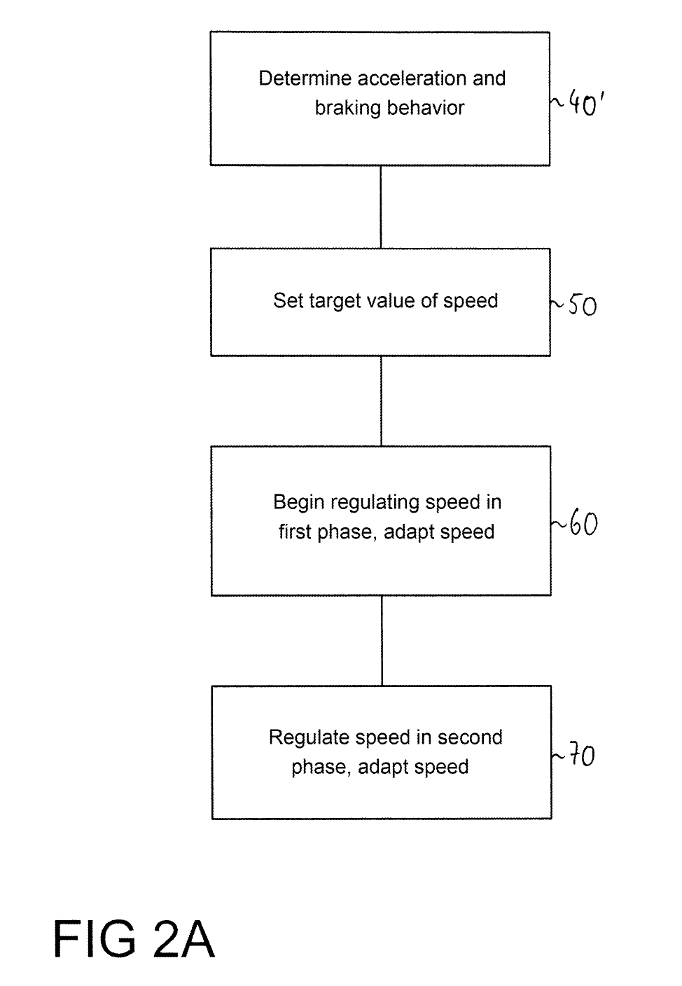

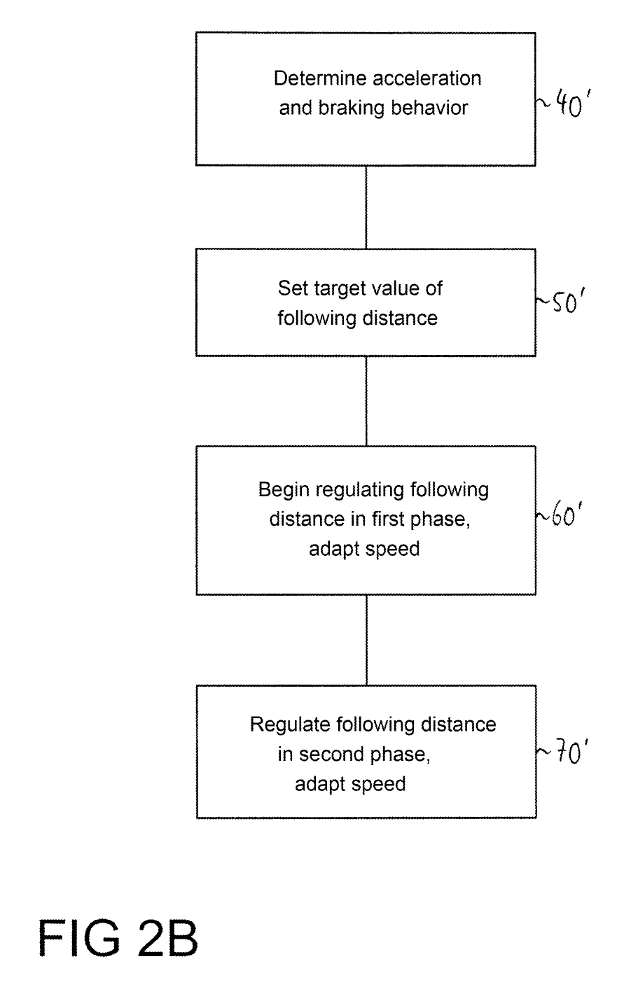

FIG. 2A shows a flow chart of a method for operating a driver assistance system of a motor vehicle according to a third embodiment. The driver assistance system is implemented to regulate a speed of the motor vehicle and the motor vehicle is a passenger automobile, for example. In a step 40′, at least one first parameter is determined, the at least one first parameter characterizing an acceleration behavior of a driver of the motor vehicle and including at least one driver-specific acceleration value, corresponding to step 40 of the first embodiment shown in FIG. 1A. Furthermore, in the third embodiment shown, at least one second parameter characterizing a braking behavior of the driver of the motor vehicle is determined in step 40′, the at least one second parameter including at least one driver-specific deceleration value. For example, a time fraction, or a frequency of acceleration values can be ascertained, which are between approximately 0.3 g and approximately 0.5 g or which exceed the threshold value of approximately 0.5 g.

In a step 50, a target value of the speed of the motor vehicle to be regulated is set by an occupant of the motor vehicle, for example, the driver. The speed is regulated to the set target value in the first embodiment in a first phase and a second phase. In the first phase, after beginning the regulation to the set target value, the speed of the motor vehicle is adapted based on the at least one driver-specific acceleration value and additionally based on the at least one driver-specific deceleration value, as shown in step 60.

The determination of the acceleration behavior and braking behavior can additionally include ascertaining at least one value of a yaw rate and/or a lateral acceleration of the motor vehicle. In this embodiment, the speed of the motor vehicle is additionally adapted in the first phase, after beginning the regulation to the set target value, based on the at least one ascertained value. In the second phase of the regulation of the speed, which is shown in a step 70, the speed of the motor vehicle is adapted based on a predetermined acceleration value and a predetermined deceleration value and therefore independently of the driving style of the driver.

FIG. 2B shows a flow chart of a method for operating a driver assistance system of a motor vehicle according to a fourth embodiment. The driver assistance system is implemented to regulate a following distance of the motor vehicle to a further motor vehicle and the motor vehicle and the further motor vehicle are passenger automobiles, for example. In a step 40′, at least one first parameter is determined, the at least one first parameter characterizing an acceleration behavior of the driver of the motor vehicle and including at least one driver-specific acceleration value. In addition, in step 40′, at least one second parameter characterizing a braking behavior of the driver of the motor vehicle is determined, the at least one parameter including at least one driver-specific deceleration value. Step 40′ of the fourth embodiment corresponds to step 40′ of the third embodiment shown in FIG. 2A. In a step 50′, a target value is set, of the following distance to be regulated of the motor vehicle, by an occupant of the motor vehicle, for example, by the driver of the motor vehicle.

The following distance is regulated to the set target value in the embodiment shown in a first phase and a second phase. In the first phase, after beginning the regulation to the set target value, the speed of the motor vehicle being adapted based on the at least one driver-specific acceleration value and additionally based on the at least one driver-specific deceleration value, as shown in a step 60′. The determination of the acceleration and braking behavior can additionally include ascertaining at least one value of a yaw rate and/or a lateral acceleration of the motor vehicle. In this embodiment, the speed of the motor vehicle is additionally adapted in the first phase, after beginning the regulation to the set target value, based on the at least one ascertained value. In the second phase of the regulation of the following distance, which is shown by a step 70′, the speed of the motor vehicle is adapted based on a predetermined acceleration value and a predetermined deceleration value.

The embodiments shown advantageously allow consideration of the individual acceleration behavior of the driver of the motor vehicle. The level of the acceleration set by the driver assistance system of the motor vehicle in the event of a change of the desired speed or the desired following distance, i.e., in the event of a change of the target value of the speed or the target value of the following distance, is a function, for example, of the average or a typical acceleration of the vehicle and therefore of the driving style of the driver, which allows an increase in comfort for the driver. The acceleration regulated by the cruise control or the adaptive cruise control therefore corresponds to an increased extent to the acceleration which the driver would select himself during travel without the driver assistance system. The acceptance of such a system is therefore additionally increased.

For example, at the beginning of travel, in the so-called baseline phase, the acceleration and deceleration behavior of a driver is studied in such a manner that static characteristic variables are calculated, which reflect the level of typical acceleration and deceleration values. The cruise control or the adaptive cruise control of the motor vehicle regulates higher or lower acceleration or deceleration values as a function of these values in the event of a driver-side change of the desired speed or the desired following distance.

A further embodiment provides making the acceleration or deceleration values dependent on characteristic variables, for example, lateral acceleration or yaw rate. These make a statement about the sportiness of the driving style of the driver and are accordingly also a measure of the level of acceleration or deceleration values of the cruise control or adaptive cruise control. In a further embodiment, driver coding is performed via the vehicle key. A “sport/touring” switch element, i.e., an operating element of an adaptive damping system of the motor vehicle, which can also be designated as an interactive dynamic driving system or flex ride, can be used as a further source for driving behavior or driving style information.

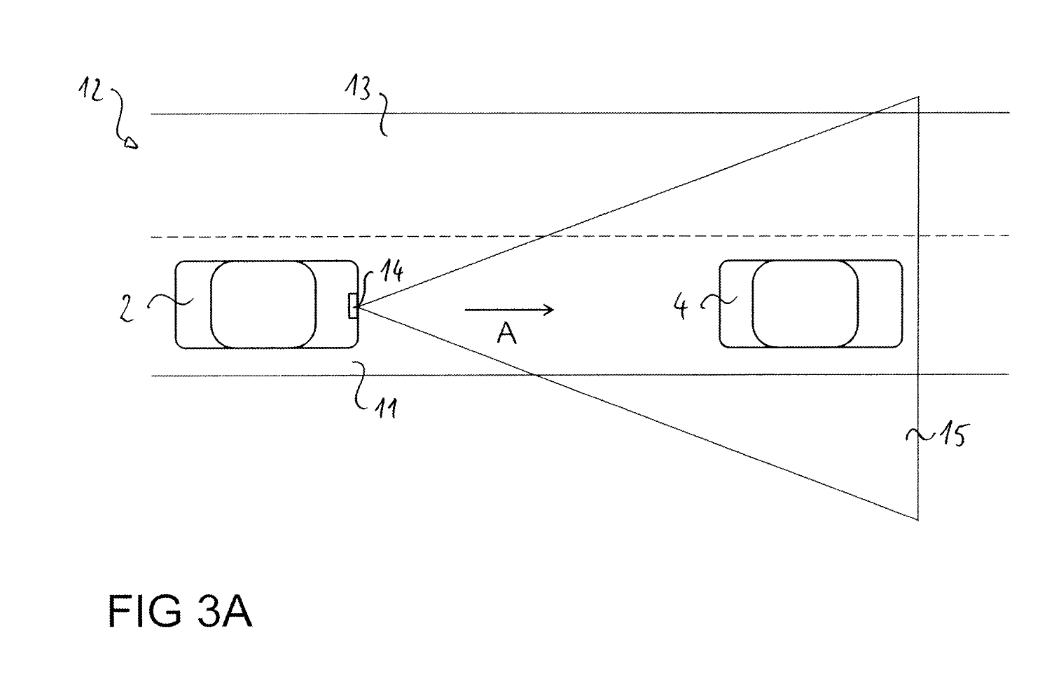

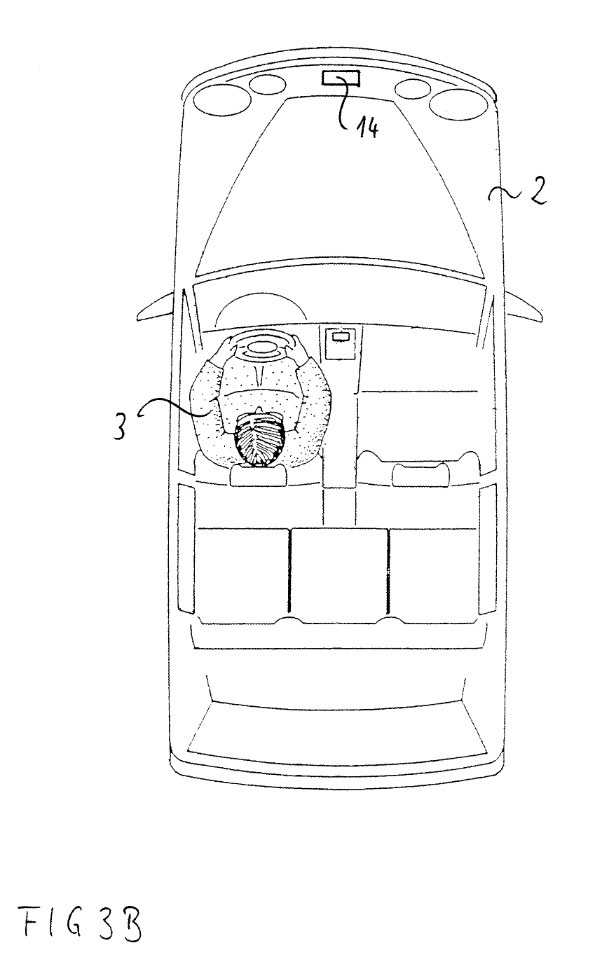

FIG. 3A shows an example of a traffic situation, in which the method according to the embodiments, in particular the method according to the embodiments shown in FIG. 1A to FIG. 2B, can be used. In the illustrated traffic situation, a first motor vehicle 2, which is a passenger automobile in the embodiment shown, travels in a travel direction schematically shown by means of an arrow A on a first lane 11 of a roadway 12. In addition to the first lane 11, the roadway 12 has a further lane 13 and is part of a highway or a freeway, for example. In the travel direction of the first motor vehicle 2, a second motor vehicle 4 travels in front of it on the first lane 11. The second motor vehicle 4 is also a passenger automobile in the situation shown.

The first motor vehicle 2 has a sensor 14, which is a component of a driver assistance system (not shown in detail in FIG. 3A) of the first motor vehicle 2. The sensor 14 is implemented as a runtime-based radar sensor or lidar sensor, for example, and has a schematically shown detection area 15. The second motor vehicle 4 is located inside the detection area 15, whereby a distance and a speed of the second motor vehicle 4 to the first motor vehicle 2 can be ascertained by means of data ascertained by the sensor 14.

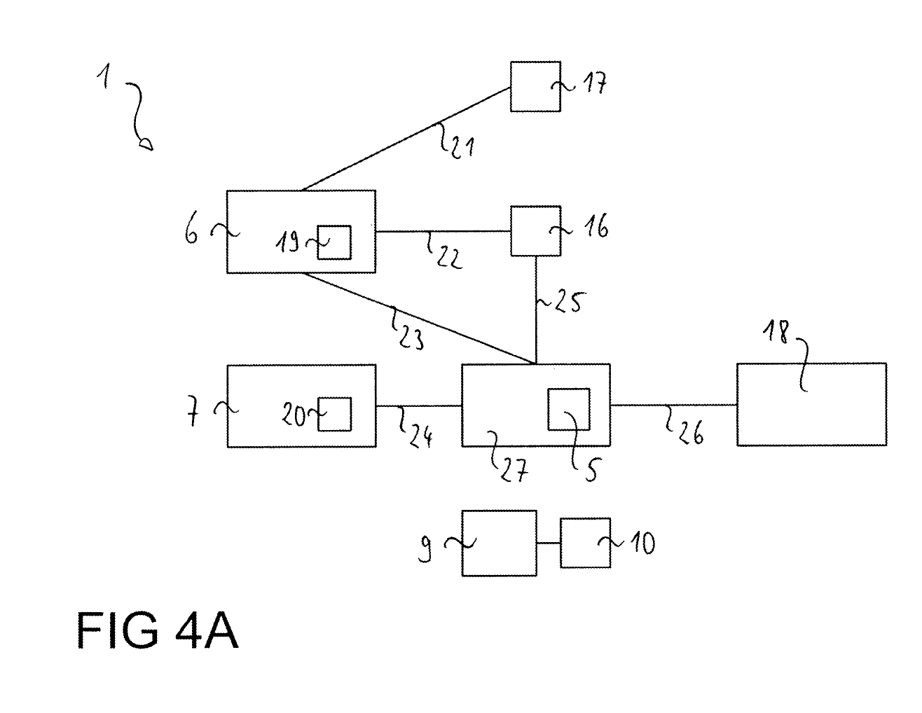

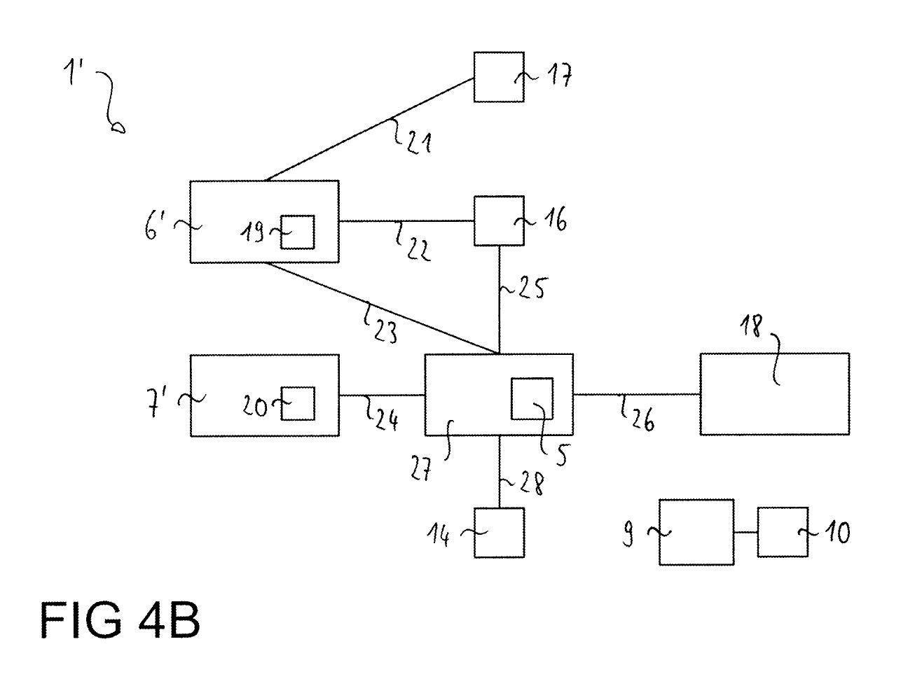

FIG. 3B shows the first motor vehicle 2 shown in FIG. 3A. Components having the same functions as in FIG. 3A are identified by the same reference numerals and are not explained once again hereafter. As explained in detail in connection with the following figures, a speed of the first motor vehicle 2 or a following distance of the first motor vehicle 2 to the second vehicle can be regulated based on an ascertained acceleration behavior and optionally an ascertained deceleration behavior of a current driver 3 of the first motor vehicle 2. For this purpose, FIG. 4A shows a driver assistance system 1 of the first motor vehicle shown in FIG. 3A and FIG. 3B according to a first embodiment.

The driver assistance system 1 is implemented to regulate a speed of the first motor vehicle and has a first ascertainment device 6, which is implemented to determine at least one parameter, the at least one parameter characterizing an acceleration behavior of a driver of the first motor vehicle and including at least one driver-specific acceleration value. For this purpose, the first ascertainment device 6 is connected via a signal line 22 to a sensor 16, which is implemented to ascertain the speed of the first motor vehicle. Furthermore, the first ascertainment device 6 has an operating element 19, where the at least one parameter can be determined by means of an input by an occupant of the first motor vehicle.

In addition, the first ascertainment device 6 can be implemented to determine the acceleration behavior of the driver by means of at least one value of a yaw rate and/or a lateral acceleration of the first motor vehicle. For this purpose, the first ascertainment device 6 is connected via a signal line 21 to an appropriately implemented sensor 17. The driver assistance system 1 additionally has a setting device 7, which is implemented to set a target value of the speed of the first motor vehicle. The setting device 7 has an operating element 20 for this purpose, by means of which the target value of the speed can be input by an occupant of the first motor vehicle.

The regulation of the speed to the set target value is performed in the embodiment shown in a first phase and a second phase, the driver assistance system 1 being implemented to adapt the speed of the first motor vehicle based on the at least one driver-specific acceleration value in the first phase after beginning the regulation to the set target value. The driver assistance system 1 has a regulating unit 27 for this purpose, which is connected via a signal line 23 to the first ascertainment device 6, via a signal line 24 to the setting device 7, and via a signal line 25 to the sensor 16. Furthermore, the regulating unit 27 is connected via a signal line 26 to an actuator 18 of a drive device of the first motor vehicle. In addition, the regulating unit 27 has a storage device 5, in which the at least one ascertained parameter can be stored.

Moreover, in the embodiment shown, the driver assistance system 1 has a computer unit 9 and a computer-readable medium 10, a computer program product being stored on the computer-readable medium 10 which, when it is executed on the computer unit 9, instructs the computer unit 9 to execute the steps mentioned in connection with the embodiments of the method according to the application, in particular the steps according to the first embodiment shown in FIG. 1A, by means of the elements mentioned therein. For this purpose, the computer unit 9 is directly or indirectly connected in a way not shown in detail to the corresponding elements.

FIG. 4B shows a driver assistance system 1′ according to a second embodiment of the application. Components having the same functions as in FIG. 4A are identified by the same reference numerals and are not explained once again hereafter. The driver assistance system 1′ is implemented to regulate a following distance of the first motor vehicle to a further motor vehicle and has a first ascertainment device 6′, which is implemented to determine at least one parameter. The at least one parameter characterizing an acceleration behavior of a driver of the first motor vehicle and including at least one driver-specific acceleration value.

Furthermore, the driver assistance system 1′ has a setting device 7′, which is implemented to set a target value of the following distance of the motor vehicle. The regulation of the following distance to the set target value is performed in the embodiment shown in a first phase and a second phase, the driver assistance system 1′ being implemented to adapt the speed of the first motor vehicle based on the at least one driver-specific acceleration value in the first phase after beginning the regulation to the set target value. For this purpose, the driver assistance system 1′ has a regulating unit 27, which is connected via a signal line 23 to the first ascertainment device 6′, via a signal line 24 to the setting device 7′, via a signal line 25 to the sensor 16, and via a signal line 28 to the sensor 14. Furthermore, the regulating unit 27 is connected via a signal line 26 to the actuator 18.

In addition, in the embodiment shown, the driver assistance system 1′ has a computer unit 9 and a computer-readable medium 10, a computer program product being stored on the computer-readable medium 10, which, when it is executed on the computer unit 9, instructs the computer unit 9 to execute the steps mentioned in connection with the embodiments of the method according to the application, in particular the steps according to the second embodiment shown in FIG. 1B, by means of the elements mentioned therein. For this purpose, the computer unit 9 is connected directly or indirectly in a way not shown in detail to the corresponding elements.

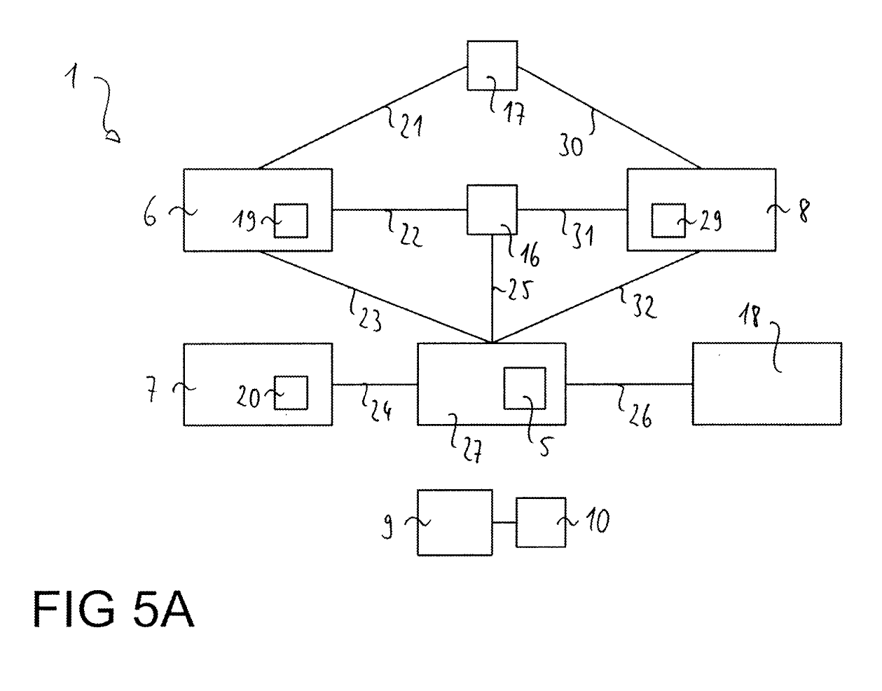

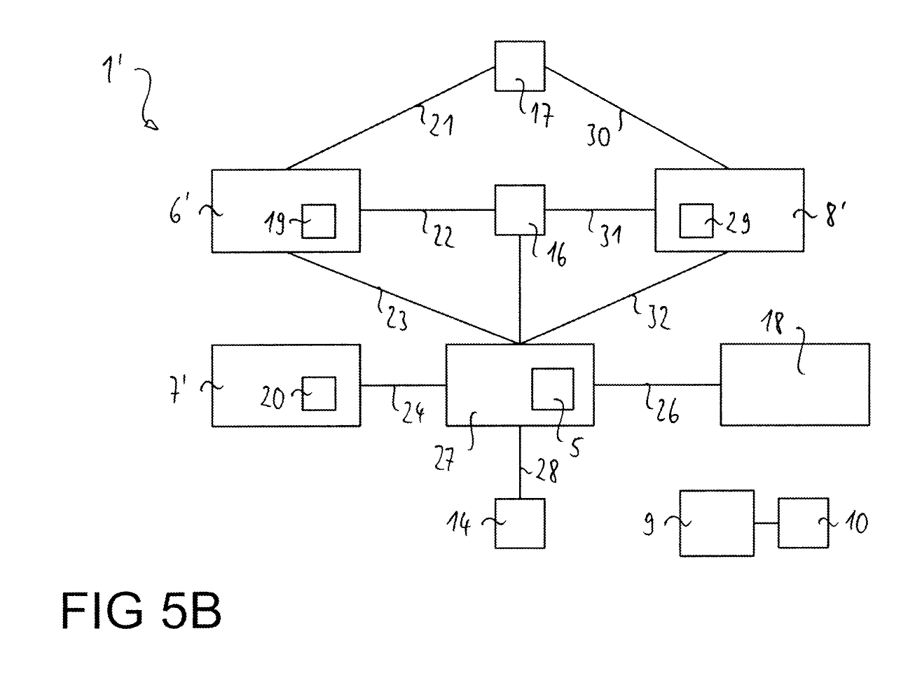

FIG. 5A shows a driver assistance system 1 according to a third embodiment. Components having the same functions as in FIG. 4A and FIG. 4B are identified by the same reference numerals and are not explained once again hereafter. The driver assistance system 1 according to the third embodiment has, in addition to the components already explained above, a second ascertainment device 8, which is implemented to determine at least one parameter characterizing a braking behavior of the driver of the first motor vehicle, the at least one parameter including at least one driver-specific deceleration value. The second ascertainment device 8 is connected for this purpose via a signal line 31 to the sensor 16 and via a signal line 30 to the sensor 17. Furthermore, the second ascertainment device 8 has an operating element 29 for this purpose, whereby the at least one parameter can be determined by means of an input by an occupant of the first motor vehicle.

The driver assistance system 1 is additionally implemented to adapt the speed of the motor vehicle based on the at least one driver-specific deceleration value in the first phase after beginning the regulation to the set target value. For this purpose, the regulating unit 27 is connected in the third embodiment shown via a signal line 32 to the second ascertainment device 8 and via a signal line 26 to at least one actuator 18 of a drive device and a brake device of the first motor vehicle 2.

In addition, in the embodiment shown, the driver assistance system 1 has a computer unit 9 and a computer-readable medium 10, a computer program product being stored on the computer-readable medium 10, which, when it is executed on the computer unit 9, instructs the computer unit 9 to execute the steps mentioned in connection with the embodiments of the method, in particular the steps according to the third embodiment shown in FIG. 2A, by means of the elements mentioned therein. For this purpose, the computer unit 9 is directly or indirectly connected in a way not shown in detail to the corresponding elements.

FIG. 5B shows a driver assistance system 1′ according to a fourth embodiment. Components having the same functions as in the preceding figures are identified by the same reference numerals and are not explained once again hereafter. The driver assistance system 1′ according to the fourth embodiment is implemented to regulate a following distance of the first motor vehicle to a further motor vehicle. The driver assistance system 1′ is implemented to adapt the speed of the first motor vehicle based on at least one driver-specific acceleration value and additionally based on at least one driver-specific deceleration value in the first phase after beginning the regulation to the set target value. For this purpose, the driver assistance system 1′ has, in addition to the first ascertainment device 6′, a second ascertainment device 8′, which is implemented to determine at least one parameter, which characterizes a braking behavior of the driver of the first motor vehicle, the at least one parameter including the at least one driver-specific deceleration value. Furthermore, the regulating unit 27 is connected for this purpose via a signal line 32 to the second ascertainment device 8′. The second ascertainment device 8′ is connected via a signal line 32 to the regulating unit 27 and this is connected via a signal line 28 to the sensor 14.

In addition, in the embodiment shown, the driver assistance system 1′ has a computer unit 9 and a computer-readable medium 10, a computer program product being stored on the computer-readable medium 10, which, when it is executed on the computer unit 9, instructs the computer unit 9 to execute the steps mentioned in connection with the embodiments of the method according to the application, in particular the steps according to the fourth embodiment shown in FIG. 2B, by means of the elements mentioned therein. For this purpose, the computer unit 9 is connected directly or indirectly in a way not shown in detail to the corresponding elements.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment. It should be understood that various changes may be made in the function and arrangement of elements described in an exemplary embodiment without departing from the scope as set forth in the appended claims and their legal equivalents.

What is claimed is:

1. A method for operating a driver assistance system of a motor vehicle, which is implemented to regulate a speed of the motor vehicle, comprising:
determining at least one parameter, the at least one parameter characterizing an acceleration behavior of a driver of the motor vehicle and including at least one driver-specific acceleration value;
setting a target value for the speed of the motor vehicle;
regulating of the speed to the target value in a first phase and a second phase; and
adapting the speed of the motor vehicle based on the at least one driver-specific acceleration value in the first phase, after beginning a regulation to the target value.

2. The method according to claim 1, further comprising:
determining at least one parameter that characterizes a braking behavior of the motor vehicle, the at least one parameter including at least one driver-specific deceleration value; and
adapting the speed of the motor vehicle based on the at least one driver-specific deceleration value in the first phase, after beginning the regulation to the target value.

3. The method according to claim 1, further comprising:
ascertaining at least one value of a yaw rate of the motor vehicle; and
adapting the speed of the motor vehicle based on the at least one value in the first phase and after beginning the regulation to the target value.

4. The method according claim 1, further comprising determining the at least one parameter for a predetermined duration after a starting procedure of the motor vehicle.

5. The method according to claim 1, further comprising continuously determining at least one parameter during operation of the motor vehicle.

6. The method according to claim 1, further comprising determining the at least one parameter with a personalized preset that is assigned to at least one ignition key of the motor vehicle.

7. The method according to claim 1, further comprising determining the at least one parameter with an occupant of the motor vehicle.

8. The method according to claim 1, further comprising storing the at least one parameter in a storage device.

9. A driver assistance system for a motor vehicle that is configured to regulate a speed of the motor vehicle, comprising:
a first ascertainment device that is configured to determine at least one parameter, the at least one parameter characterizing an acceleration behavior of a driver of the motor vehicle and including at least one driver-specific acceleration value; and
a setting device configured to set a target value of the speed of the motor vehicle,
wherein the speed is regulated to the target value in at least a first phase and one second phase, and
wherein the speed of the motor vehicle is adapted based on the at least one driver-specific acceleration value in the first phase after beginning a regulation to the target value.

10. The driver assistance system according to claim 9, further comprising a second ascertainment device that is configured to determine at least one parameter that characterizes a braking behavior of the driver of the motor vehicle,
wherein the at least one parameter include at least one driver-specific deceleration value,
wherein the speed of the motor vehicle is adapted based on the at least one driver-specific deceleration value in the first phase after beginning the regulation to the target value.

11. A computer readable medium embodying a computer program product, said computer program product comprising:
an operating program for operating a driver assistance system of a motor vehicle, which is implemented to regulate a speed of the motor vehicle, the operating program configured to:
determine at least one parameter, the at least one parameter characterizing an acceleration behavior of a driver of the motor vehicle and including at least one driver-specific acceleration value;
set a target value for a speed of the motor vehicle;
regulate of the speed to the target value in a first phase and a second phase; and
adapt the speed of the motor vehicle based on the at least one driver-specific acceleration value in the first phase, after beginning a regulation to the target value.

12. The computer readable medium embodying the computer program product according to claim 11, the operating program further configured to:
determine at least one parameter that characterizes a braking behavior of the motor vehicle, the at least one parameter including at least one driver-specific deceleration value; and
adapt the speed of the motor vehicle based on the at least one driver-specific deceleration value in the first phase, after beginning the regulation to set the target value.

13. The computer readable medium embodying the computer program product according to claim 11, the operating program further configured to:
ascertain at least one value of a yaw rate of the motor vehicle; and
adapt the speed of the motor vehicle based on the at least one value in the first phase and after beginning the regulation to the target value.

14. The computer readable medium embodying the computer program product according to claim 11, the operating program further configured to determine the at least one parameter for a predetermined duration after a starting procedure of the motor vehicle.

15. The computer readable medium embodying the computer program product according to claim 11, the operating program further configured to continuously determine at least one parameter during operation of the motor vehicle.

16. The computer readable medium embodying the computer program product according to claim 11, the operating program further configured to determine the at least one parameter with a personalized preset that is assigned to at least one ignition key of the motor vehicle.

17. The computer readable medium embodying the computer program product according to claim 11, the operating program further configured to determine the at least one parameter with an occupant of the motor vehicle.

18. The computer readable medium embodying the computer program product according to claim 11, the operating program further configured to store the at least one parameter in a storage device.
